(19) United States
(12) Patent Application Publication
(10) Pub. No.: US 2010/0238515 A1
(43) Pub. Date: Sep. 23, 2010

(54) Facsimile Apparatus

(75) Inventor: Daisuke KANUMA, Matsumoto-shi (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/709,896

(22) Filed: Feb. 22, 2010

(30) Foreign Application Priority Data
Mar. 23, 2009 (JP) 2009-070001

(51) Int. Cl. H04N 1/40

(52) U.S. Cl. 358/444

(57) ABSTRACT

A facsimile apparatus includes: a scanner unit; an operating section; a main control board having a first image memory, a second setting information storage memory, and a control section; a FAX board having a second image memory and a second setting information storage memory, and executing a facsimile transmission process of the image data in the second image memory; and a plurality of buses, wherein the control section of the main control board transfers the image data in the first image memory to the second image memory of the FAX board upon completing the acquisition of the image data by the scanner unit.

### BACKGROUND

1. Technical Field

The present invention relates to a technique which can change an output setting by a more simple operation without stopping the acquisition of image data even in a facsimile apparatus in which an image memory in which the image data acquired by scanning a manuscript is accumulated and a memory in which a facsimile transmission setting is stored are mounted on a facsimile board.

2. Related Art

Out of the facsimile apparatuses, there is one which can change the facsimile transmission setting without interrupting the process even during the period from the start of manuscript scanning to the start of image data transmission.

For example, there is a facsimile apparatus which, if an external memory is mounted at a predetermined timing during the manuscript scanning or after completion of the manuscript scanning in the case of executing the facsimile transmission out of a plurality of processes (printing, saving to an internal memory, facsimile transmission, data transmission via network, and infrared transmission), reads out the setting data corresponding to the facsimile transmission from the external memory and changes the facsimile transmission setting by the setting data (see, for example, JP-A-2008-118302). In addition, the facsimile apparatus awaits a setting data changing instruction from a user while displaying a list of the setting data read out from the external memory and, if the setting data changing instruction is provided, further changes the facsimile transmission setting by the setting data according to the setting data changing instruction. Then, if a predetermined period has passed from the completion of the scanning, data accumulated by scanning is facsimile transmitted according to the final setting data.

However, out of the facsimile apparatuses, there is another one in which all of the components necessary to transmit/receive a facsimile (an image memory in which image data acquired by manuscript scanning is accumulated, a storage memory for facsimile transmission setting or the like) are mounted on a facsimile board (a FAX board). In such a facsimile apparatus (for example, a multifunction printer in which the FAX board is retrofitted as an option or the like), during the manuscript scanning, a bus between a main control board and the FAX board is occupied by transferring the acquired image data, and thus it is difficult to change the facsimile transmission setting in a memory of the FAX board during the manuscript scanning. The above described related art does not consider the application to such a facsimile apparatus and, even in such a facsimile apparatus, does not disclose a specific configuration which allows the facsimile transmission setting to be changed during the manuscript scanning.

In addition, according to the above described related art, it is necessary to mount an external memory to an image forming apparatus in order to change the facsimile transmission setting. For example, when a user tries to change an initial value of the facsimile transmission setting which the image forming apparatus holds, it is necessary to mount the external memory to the image forming apparatus in spite of not using the setting data in the external memory. User may feel this operation is troublesome.

### SUMMARY

An advantage of some aspects of the invention is to make it possible to change an output setting by a simple operation without stopping the acquisition of image data even in a facsimile apparatus in which an image memory in which the image data acquired by scanning the manuscript is accumulated and a memory in which a facsimile transmission setting is stored are mounted on a facsimile board.

According to a first aspect of the invention, there is provided a facsimile apparatus including: a scanner unit which acquires an image data by scanning a manuscript; an operating section which accepts a setting information changing instruction regarding the facsimile transmission of the image data during acquisition by the scanner unit; a main control board having a first image memory in which the image data transferred from the scanner unit during acquisition of the image data by the scanner unit is accumulated, a second setting information storage memory in which a first setting information regarding the facsimile transmission of the image data accumulated in the first image memory is stored, and a control section which, upon receiving the changing instruction from the operating section after the starting of the image data acquisition by the scanner unit, changes the setting information in the first setting information storage memory according to the data designated by the changing instruction; a FAX board having a second image memory in which the image data transferred from the main control board is stored and a second setting information storage memory in which a setting information in the first setting information storage memory transferred from the main control board is stored, and executing a facsimile transmission process of the image data in the second image memory according to the setting information in the second setting information storage memory; and a plurality of buses which individually connect the main control board with each of the FAX board, the scanner unit and the operating section and transfer data between the FAX board, the scanner unit and the operating section via the main control board, wherein the control section of the main control board transfers the image data in the first image memory to the second image memory of the FAX board upon completing the acquisition of the image data by the scanner unit.

With this configuration, during the scanning of manuscript, the image data acquired from the scanner unit is accumulated in the first image memory of the main control board and, after completion of the manuscript scanning, the image data in the first image memory of the main control board is transferred to the second image memory of the FAX board. For this reason, the bus between the main control board and the FAX board is opened for transfer of the setting information until the image transfer from the main control board to the FAX board starts. That is, after the manuscript scanning starts, it is possible to transfer the setting information after the change from the first setting information storage memory of the main control board to the second setting information storage memory of the FAX board is executed. Accordingly, even in a facsimile apparatus in which a bus between the main control board and the FAX board is occupied by the transmission of the image data, a user can freely change the setting information, for example, the necessity of outputting a FAX transmission report, the number of times for redialing, the necessity of recording a transmission source, the existence or non-existence of overseas telecommunication, a transmission destination FAX number or the like without stopping the manuscript scanning.

In a preferred embodiment, it may be that the operating section includes a touch panel type display which displays a scan executing screen indicating that the scanner unit is acquiring the image data, and the operating section may accept input of the changing data by a touching operation to the scan executing screen.

With such configuration, a user can change the transmission setting information by simple one-touch operation on a scan executing screen which displays a progressing state of the facsimile transmission mode process (that is, without entering a setting mode purposely).

According to a second aspect of the invention, there is provided a facsimile apparatus including: a scanner unit which acquires an image data by scanning a manuscript; a main control board having a first image memory in which the image data transferred from the scanner unit during acquisition of the image data by the scanner unit is accumulated, a network communication controller which is connected to a network, a removable media controller in which a removable media is mounted, and a control section; a FAX board having a second image memory in which the image data transferred from the main control board is stored, and executing a facsimile transmission process of the image data in the second image memory; and an operating section which accepts a changing instruction to change an output destination of the image data being acquired by the scanner unit from the FAX board to the removable media or a folder on network, wherein when the operating section accepts the changing operation after starting of the acquisition of the image data by the scanner unit, the control section of the main control board outputs the image data in the first image memory to the output destination after the change designated by the changing operation accepted by the operating section in place of the second image memory of the FAX board.

With this configuration, since the image data capable of being acquired by scanning is accumulated in the image memory of the main control board until a facsimile transmission starts, it is possible to change an output mode on the way without scanning the manuscript again.

According to the invention, it is possible to change an output setting by a more simple operation without stopping the acquisition of image data even in a facsimile apparatus in which an image memory in which the image data acquired by scanning the manuscript is accumulated and a memory in which a facsimile transmission setting information is stored are mounted on a FAX board.

### BRIEF DESCRIPTION OF THE DRAWINGS

The invention will be described with reference to the accompanying drawings, wherein like numbers reference like elements.

FIG. 1 shows a schematic configuration of a multifunction printer according to a first embodiment of the invention.

FIG. 2 shows a flow chart of a facsimile transmission mode process according to the first embodiment of the invention.

FIGS. 3A to 3D show examples of switching of a user interface displayed during execution of the facsimile transmission mode process according to the first embodiment of the invention.

FIG. 4A shows another user interface example displayed during execution of scanning and FIG. 4B shows another user interface example displayed during standby of the facsimile transmission.

FIG. 5 shows a flow chart of an image data output process according to another embodiment of the invention.

FIG. 6A to 6C show examples of user interfaces displayed during execution of the image data output process according to another embodiment of the invention.

### DESCRIPTION OF EXEMPLARY EMBODIMENTS

Hereinafter, embodiments of the invention will be described with reference to the accompanying drawings.

Firstly, configuration of a facsimile apparatus according to this embodiment will be explained. Here, as an example of the facsimile apparatus, a multifunction printer (MFP) in which office equipment functions such as a facsimile function, an image scanner function or the like are integrated will be cited.

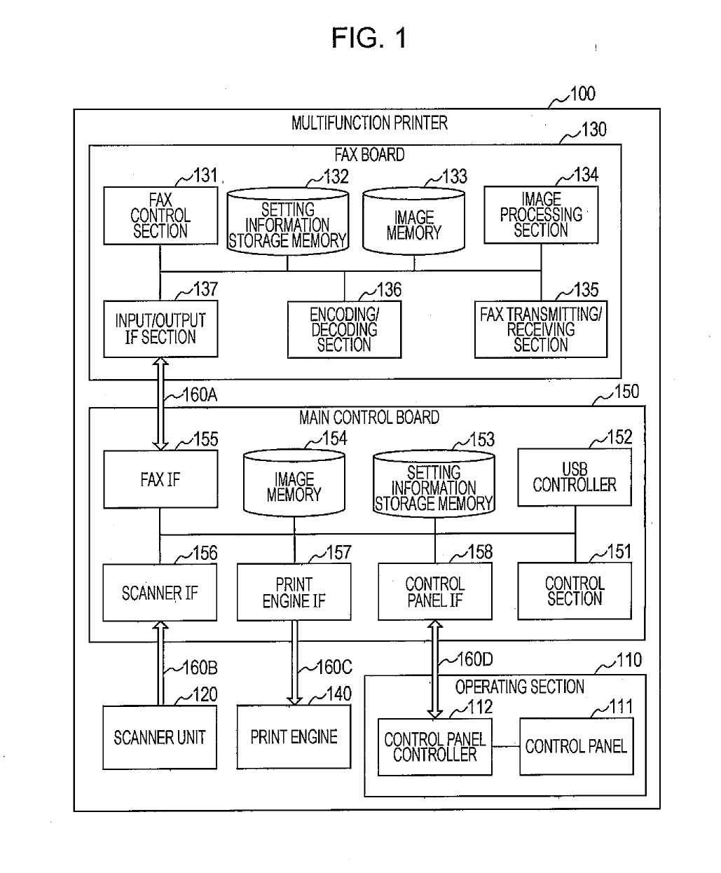

FIG. 1 shows a schematic configuration of a multifunction printer according to an embodiment of the invention.

As shown, the multifunction printer 100 includes an operating section 110 which accepts operation of user, a scanner unit 120 which acquires image data by scanning a manuscript, a FAX board 130 which facsimile transmits/receives the image data, a print engine 140 which prints the image data, a main control board 150 which performs overall control of the multifunction printer 100, a hard disk (not shown), and dedicated buses 160A to 160D which individually connect the main control board 150 with each of the other section 110 to 140.

The operating section 110 includes a control panel 111 having a touch panel type display on which a user interface which will be described later is displayed and operation keys, and a control panel controller 112 which controls the control panel 111, and exchanges an input/output data of the control panel 111 with the main control board 150 via a dedicated bus 160D.

The scanner unit 120 has a hardware configuration (a platen, an optical system, ADF and the like) as a typical scanner which reads image data from a manuscript on the platen or a manuscript being conveyed, and outputs a read image data to the main control board 150 via a dedicated bus 160B.

The FAX board 130 includes an input/output interface 137 which is connected to the main control board 150 via a dedicated bus 160A, a setting information storage memory 132 in which a setting information regarding a facsimile transmission (facsimile transmission setting information) is stored as a fax job, an image memory 133 in which the image data is stored, an image processing section 134 which converts resolution of the image data, a FAX transmitting/receiving section (modem) 135 which transmits/receives the image data via telephone line, an encoding/decoding circuit 136 which compresses a transmitting image data or expands a received image data, a FAX control section 131 which controls each of these sections 132 to 136, and the like. Further, the FAX control section 131 is realized, for example, by a CPU, a program memory in which a communication program or the like is stored, a main memory, a data memory or the like.

The print engine 140 includes a hardware configuration (a paper conveying mechanism, a printing section, a print controller or the like) as a typical printing mechanism for recording the image on a printing paper being conveyed, and prints the printing data transferred from the main control board 150 via a dedicated bus 160C (for example, an image data acquired by the scanner unit 120, a log data regarding facsimile transmission/reception (a FAX log data) or the like).

The main control board 150 includes a USB controller 152 having USB ports, a network communication controller (not shown) having a network interface, a setting information storage memory 153 in which a facsimile transmission setting information or the like is stored, an image memory 154 in which the image data from the scanner unit 120 is stored, a FAX interface 155 to which the FAX board 130 is connected via a dedicated bus 160A, a scanner interface 156 to which the scanner unit 120 is connected via a dedicated bus 160B, a printer interface 157 to which the print engine 140 is connected via a dedicated bus 160C, a control panel interface 158 to which the operating section 110 is connected via a dedicated bus 160D, a control section 151 which controls each of these sections 152 to 155, and the like. Further, the control section 151 is realized, for example, by a CPU, a program memory in which a control program of the multifunction printer 100 or the like is stored, a data memory, a main memory or the like.

With regard to the multifunction printer 100, at any time until a facsimile transmission of the image data starts, a user can change the value of each of the parameters included in the facsimile transmission setting information simply by a simple operation of the control panel 111 without mounting any particular external equipment such as an external memory. Next, such a facsimile transmission mode process will be described. Further, here, for convenience of description, a case in which only the value of a parameter (a report output parameter) indicating the necessity of outputting a FAX transmission report after completion of the facsimile transmission out of the parameters included in the facsimile transmission setting information can be changed on the way is cited as an example.

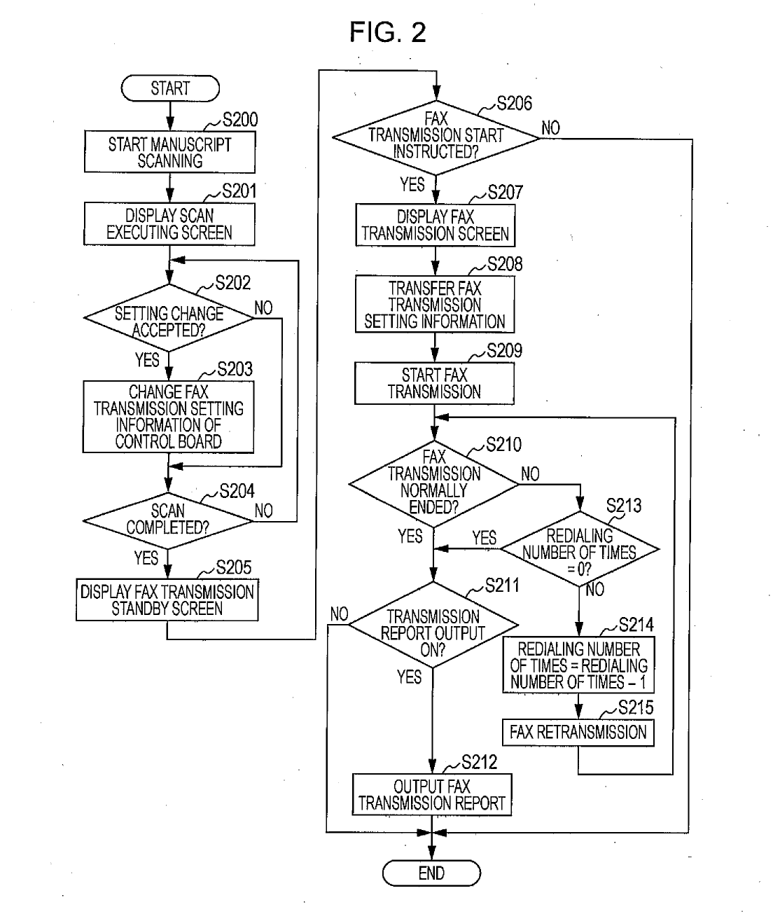

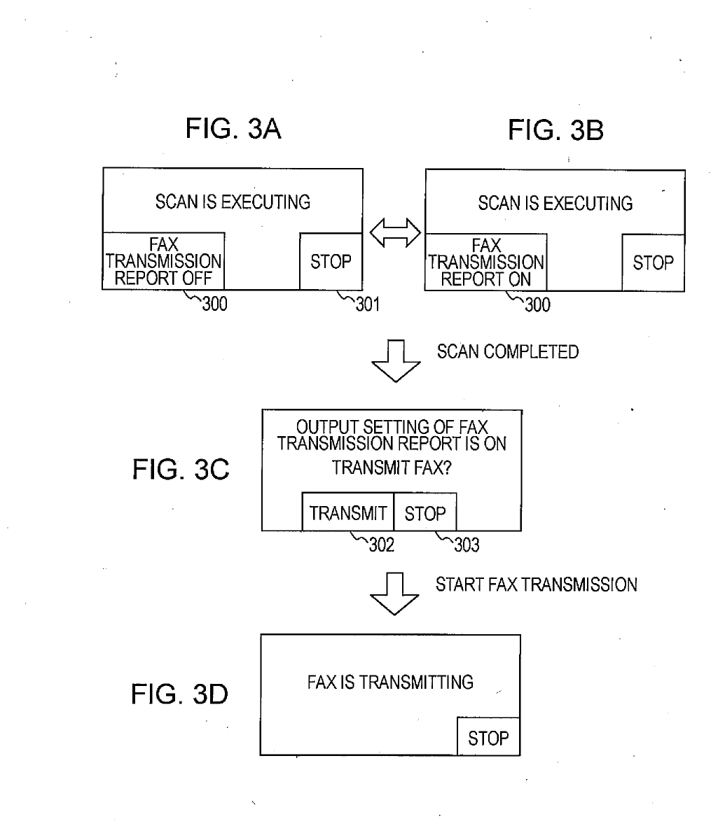

FIG. 2 shows a flow chart of a facsimile transmission mode process according to this embodiment, and FIGS. 3A to 3D show a series of examples of a user interface displayed during execution of the facsimile transmission mode process.

In order to facsimile transmit a manuscript through the multifunction printer 100, firstly, a user needs to set the manuscript on the scanner unit 120 and select a facsimile transmission mode button out of a plurality of the output mode buttons displayed on initial screen on a display of the control panel 111. Subsequently, if values are set for at least the essential parameters (for example, transmission destination FAX number) out of the parameters of the facsimile transmission setting information on a FAX transmission setting screen displayed on a display of the control panel 111 and then a start key of the control panel 111 is pressed, the following facsimile transmission mode process starts.

If the control panel controller 112 detects depression of the start button, it notifies the meaning to the main control board 150 and passes a set value of each parameter of the facsimile transmission setting information to the main control board 150. Further, as for the parameters the values of which were not set by a user on the FAX transmission setting screen out of any parameters of the facsimile transmission setting information (for example, a report output parameter, a number of times for redialing parameter indicating the number of times for redialing, a transmission source recording parameter indicating the necessity of recording the transmission source, an overseas transmission parameter indicating the existence or nonexistence of overseas transmission or the like), default values (for example, the report output parameter “OFF”, the number of times for redialing parameter “0 times”, the transmission source recording parameter “unnecessary”, the overseas transmission parameter “nonexistence”) are passed to the main control board 150 as setting values. Here, since the user did not set a value for the report output parameter, a default value “OFF” as a set value of the report output parameter is adapted to be passed to the main control board 150.

In the main control board 150, if the control section 151 accepts a notification from the control panel controller 112, the control section 151 stores the passed facsimile transmission setting information in the setting information storage memory 153. In addition, the control section 151 controls the scanner unit 120 to start a manuscript scanning (S200). Thus, the image data which are sequentially output from the scanner unit 120 are transferred to and accumulated in the image memory 154 of the main control board 150 until the manuscript scanning is completed.

Once the manuscript scanning starts, according to the instructions from the main control board 150, the control panel controller 112 displays, on a display of the control panel 111, a scan executing screen which accepts an operation of changing the values of the parameters included in the facsimile transmission setting information (S201).

On the scan executing screen, as shown in FIG. 3A, a message indicating that the manuscript scanning is executing, a setting change button 300 for changing the value of the report output parameter from the present setting value “OFF” to “ON”, and a stop button 301 for stopping the manuscript scanning are displayed. Here, on the setting change button 300, a character string which represents the present setting value “OFF” is displayed.

For example, here, if a user presses a setting change button 300, the control panel controller 112 detects this (S202: Yes) and, as shown in FIG. 3B, switches the character string “OFF” on the setting change button 300 of the scan executing screen to a character string representing a new setting value “ON” of the report output parameter and notifies the new setting value “ON” of the report output parameter to the main control board 150. Further, if a user presses the setting change button 300 many times, on each case, the character string on the setting change button 300 is switched (from “OFF” to “ON” or from “ON” to “OFF”) and the new setting values (“OFF” or “ON”) of the report output parameters are notified.

In the main control board 150, whenever the control section 151 accepts a notification of a new setting value “ON” of the report output parameter from the control panel controller 112, the control section 151 updates a value of the report output parameter of the facsimile transmission setting information of the setting information storage memory 153 to a new setting value “ON” (S203).

Next, if the completion of the manuscript scanning is notified from the scanner unit 120 (S204: Yes), the control section 151 instructs the control panel controller 112 to switch the display to a facsimile transmission standby screen. When the number of scanned manuscript is below or equal to a predetermined number, it may be possible to instruct the switching of the display to the facsimile transmission standby screen after a predetermined period (for example, about 3 seconds) has passed from the notification of the completion of the manuscript scanning. If so, even in a case in which the number of manuscripts is small or the like, time is secured to the extent a user is able to execute a changing operation of the facsimile transmission setting information on the scan executing screen in good time.

The control panel controller 112 displays, according to the instruction from the main control board 150, a facsimile transmission standby screen which accepts an instruction to start a facsimile transmission on a display of the control panel 111 (S205).

On a facsimile transmission standby screen, as shown in FIG. 3C, a message which urges confirmation of the present setting values of the report output parameters (here, “ON”) and input of the instruction to start a facsimile transmission, a transmission button 302 for starting the facsimile transmission, and a stop button 303 for stopping the facsimile transmission are displayed. Here, if a user presses the transmission button 302 according to the message, the control panel controller 112 detects depression of the transmission button 302 (S206: Yes), notifies the meaning thereof to the main control board 150, and displays the facsimile transmission screen shown in FIG. 3D on a display of the control panel 111 (S207).

In the main control board 150, if the control section 151 accepts a notification from the control panel controller 112 within a predetermined period or does not accept a notification from the control panel controller 112 within a predetermined period and thus times out, the control section 151 reads out the facsimile transmission setting information from the setting information storage memory 153 and instructs the FAX board 130 to register this facsimile transmission setting information. In the FAX board 130, the FAX control section 131 stores this facsimile transmission setting information as a fax job in the setting information storage memory 132 (S208).

After transfer of the facsimile transmission setting information to the FAX board 130 is completed, in the main control board 150, the control section 151 instructs the FAX board 130 to transmit the facsimile and starts a transfer of the image data from the image memory 154 to the image memory 133 of the FAX board 130.

In the FAX board 130, the image data stored in the image memory 133 is subject to an appropriate resolution conversion process and a compression process by an encoding system according to a FAX transmission destination and the like by the image processing section 134 and the encoding/decoding section 136, and then facsimile transmitted from the FAX transmitting/receiving section 135 to a transmission destination designated by a transmission destination FAX number of corresponding facsimile transmission setting information in the setting information storage memory 132 (S209).

If facsimile transmission of the image data is ended normally (S210: Yes), the FAX control section 131 saves the FAX log data (the ending status of the facsimile transmission, the transmission time, the transmission destination FAX number or the like) and notifies the ending status of the facsimile transmission (normal ending) to the main control board 150. In response to this, the control section 151 of the main control board 150 executes a general notification process such as the output of a notification sound from a speaker to notify the normal ending of the facsimile transmission to a user.

On the other hand, if facsimile transmission of the image data is not ended normally (S210: No), the FAX control section 131 determines whether the value of the number of times for redialing parameter of corresponding facsimile transmission setting information in the setting information storage memory 132 is 0 times or not (S213).

Here, if the value of the number of times for redialing parameter is 0 times (S213: Yes), the FAX control section 131 saves the FAX log data and notifies the ending status of facsimile transmission (abnormal ending) to the main control board 150. In response to this, the control section 151 of the main control board 150 executes a general notification process such as the output of a notification sound from a speaker to notify the abnormal ending of the facsimile transmission to a user.

In addition, if the value of the number of times for redialing parameter of corresponding facsimile transmission setting information in the setting information storage memory 132 is larger than 0 times (S213: No), the FAX control section 131 reduces the value of the number of times for redialing parameter only by one and then awaits the elapse of a predetermined time. At this time, it is also possible that a screen which displays a setting change button (a setting change button to change a value of the report output parameter from the present setting value) such as the setting change button 300 on a scan executing screen is displayed on a display of the control panel 111 to allow a user to change a value of the report output parameter. In this case, it is preferable to make the control section 151 of the main control board 150 instruct the FAX board 130 to change a value of the report output parameter whenever the setting change button is operated.

If the predetermined time has passed, the FAX control section 131 executes a facsimile transmission of the image data in the image memory 133 (S215) again. Then, the processes subsequent to S210 are repeated until the value of the number of times for redialing parameter is 0 times (until S213 is Yes) or until the image data is ended normally (until S210 is Yes) before the value of the number of times for redialing parameter is 0 times.

If the facsimile transmission is normally or abnormally ended by doing so, the FAX control section 131 determines whether a value of the report output parameter of corresponding facsimile transmission setting information in the setting information storage memory 132 is “ON” or not (S211). Only in a case in which the value of the report output parameter is “ON”, the FAX control section 131 instructs the main control board 150 to output a FAX transmission report, and passes a FAX log data (the ending status of the facsimile transmission, the transmission time, the transmission destination FAX number or the like). In response to this, the control section 151 of the main control board 150 controls the print engine 140 to print a FAX transmission report in which the FAX log data is described (S212).

According to such a facsimile apparatus, during the manuscript scanning', the image data acquired from the scanner unit is accumulated in the image memory 154 of the main control board 150, and after completion of the manuscript scanning, the image data is transferred from the image memory 154 of the main control board 150 to the image memory 133 of the FAX board 130.

For this reason, a bus 160A between the main control board 150 and the FAX board 130 is not occupied until the transfer of the image data starts, and opened for transfer of the facsimile transmission setting information. That is, although the manuscript scanning starts, it is possible to transfer the parameter value of the facsimile transmission setting information from the main control board 150 to the FAX board 130 after the change. Accordingly, even after the manuscript scanning starts, a user can freely change the facsimile transmission setting information which has been set prior to the start of the manuscript scanning, without stopping the manuscript scanning. For example, even in a case in which a user found it necessary to output the FAX transmission report after the manuscript scanning starts or the like, the user can change the facsimile transmission setting information on the way to make the FAX transmission report be output after completion of the facsimile transmission and thus a high degree of convenience is obtained.

In addition, a user can change the facsimile transmission setting information with a simple one touch operation on a screen displaying the progress state of the facsimile transmission mode process (that is, without purposely entering a setting mode and switching to a FAX transmission setting screen). Further, unlike the related art which necessitates mounting of the external memory to change the setting data, it is unnecessary to mount other external equipment to the multifunction printer 100. For this reason, according to the facsimile transmission mode process of this embodiment, operability in changing the facsimile transmission setting information is improved.

In addition, although this embodiment cites a case in which only the value of the report output parameter out of the parameters included in the facsimile transmission setting information can be changed on the way, the values of the other parameters included in the facsimile transmission setting information may be similarly changed on the way.

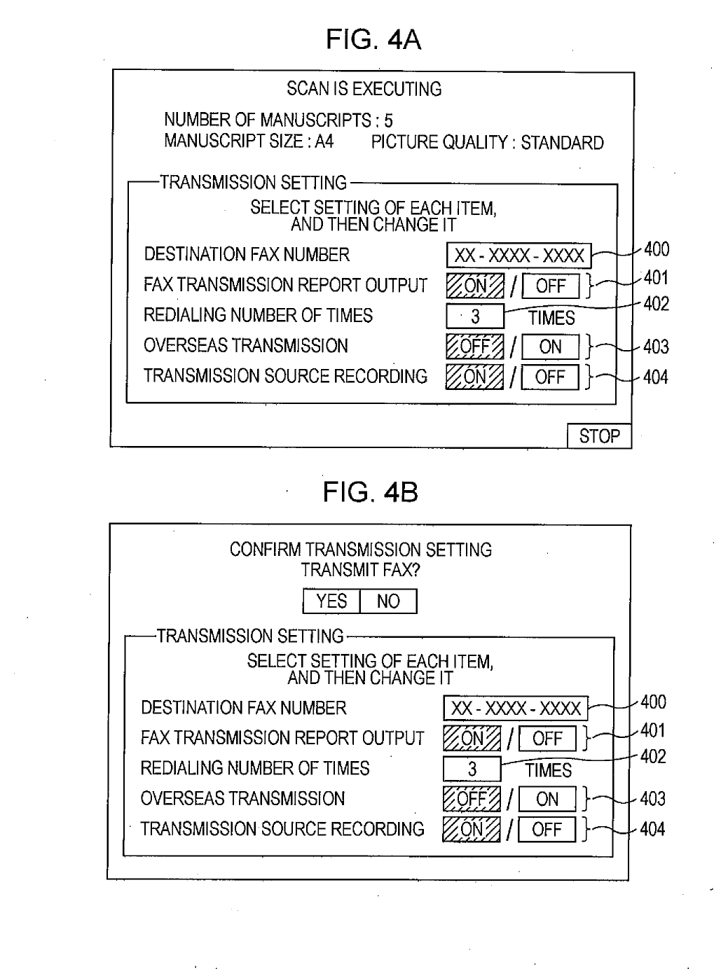

For example, in a case in which the transmission destination FAX number, the number of times for redialing parameter, the overseas transmission parameter and the transmission source recording parameter other than the report output parameter can also be changed on the way, it is preferable to display a scan executing screen to change the value of each parameter from the present setting value to another value, as shown in FIG. 4A, in S202. On this scan executing screen, for example, an input field 400 of the transmission destination FAX number, a toggle button 401 to change the value (ON/OFF) of the report output parameter, an input field 402 to accept an input of the value of number of times for redialing parameter, a toggle button 403 to change the value of the overseas transmission parameter (ON/OFF), and a toggle button 404 to change the value of the transmission source recording parameter (ON/OFF) are displayed. The initial state of each setting change tool 400 to 404 represents the present setting value of the corresponding parameter.

Further, although, in this embodiment, the change of the setting values of the parameters included in the facsimile transmission setting information is adapted to be accepted only on a scan executing screen, the change may be accepted on the facsimile transmission standby screen displayed in S206. Such a facsimile transmission standby screen may display the same setting change tool as a scan executing screen together with a message requesting confirmation of the FAX transmission setting.

For example, in a case as described above in which the report output parameter, the transmission destination FAX number, the number of times for redialing parameter, the overseas transmission parameter and the transmission source recording parameter can be changed on the way until the facsimile transmission starts, it is preferable to display the same setting change tool 400 to 404 as a scan executing screen on the facsimile transmission standby screen as shown in FIG. 4B.

Further, although, in this embodiment, the facsimile transmission setting information in the setting information storage memory 153 of the main control board 150 is adapted to be transferred to the setting information storage memory 132 of the FAX board 130 at a timing (S208) immediately before starting a transfer of the image data from the image memory 154 of the main control board 150 to the image memory 133 of the FAX board 130 after completion of the manuscript scanning, it does not always have to do so.

For example, it is also permitted to make the facsimile transmission setting information in the setting information storage memory 153 of the main control board 150 be transferred to the setting information storage memory 132 of the FAX board 130 at the earlier timing out of the timing when a predetermined period elapses from the start of the manuscript scanning and the timing when the manuscript scanning is completed.

In addition, during the facsimile transmission of the image data, a change of the setting values of the parameters (for example, the report output parameter, the number of times for redialing parameter or the like) other than the transmission destination FAX number included in the facsimile transmission setting information may be accepted on a facsimile transmission screen. In order to do so, for example, it is preferable that, whenever the facsimile transmission setting information in the setting information storage memory 153 of the main control board 150 is updated by changing operation on a facsimile transmission screen, the contents of the facsimile transmission setting information in the setting information storage memory 153 of the main control board 150 after the change are reflected in the facsimile transmission setting information of the setting information storage memory 132 of the FAX board 130.

Incidentally, although the facsimile transmission setting can be changed on the way after the start of the manuscript scanning in the foregoing, the output mode may be changed on the way after start of the manuscript scanning.

Next, with reference to a case in which an output mode of the multifunction printer 100 is changed on the way from the above described facsimile transmission mode to another output mode after the start of the manuscript scanning, an image data output process in which the multifunction printer 100 outputs the image data in an output mode after the change will be described. Here, as an example of the output mode other than the above described facsimile transmission mode, a save mode (scan to folder, scan to USB) in which the image data is saved in a designated folder or a removable media (here, a USB memory) and an E-mail transmission mode in which the image data is transmitted by E-mail (scan to mail) are cited.

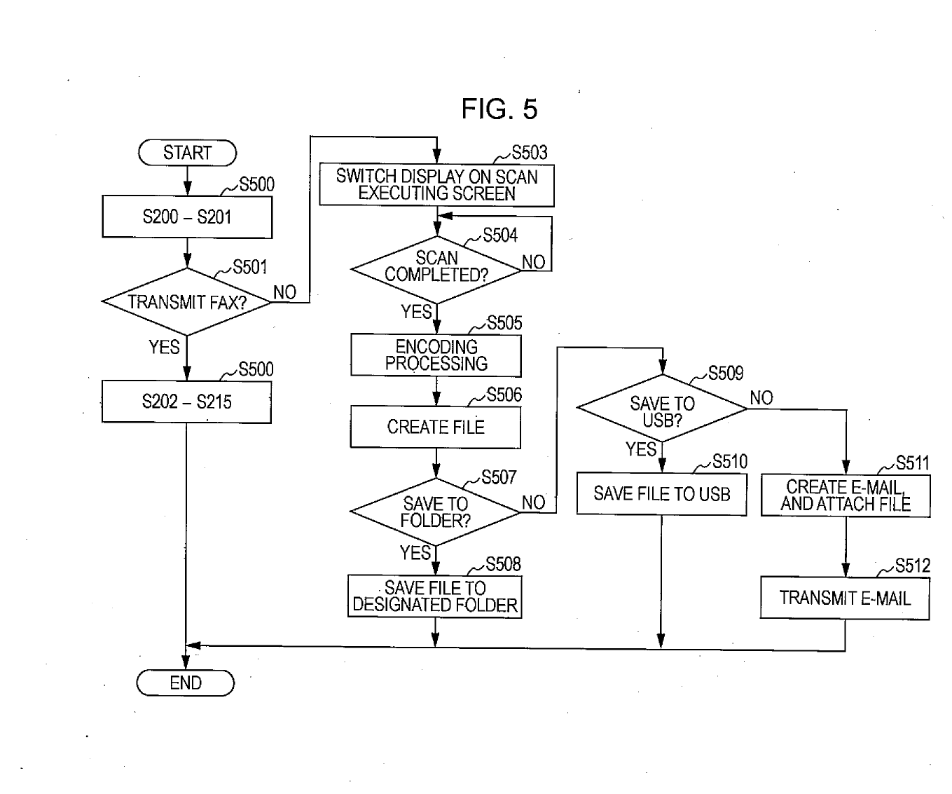

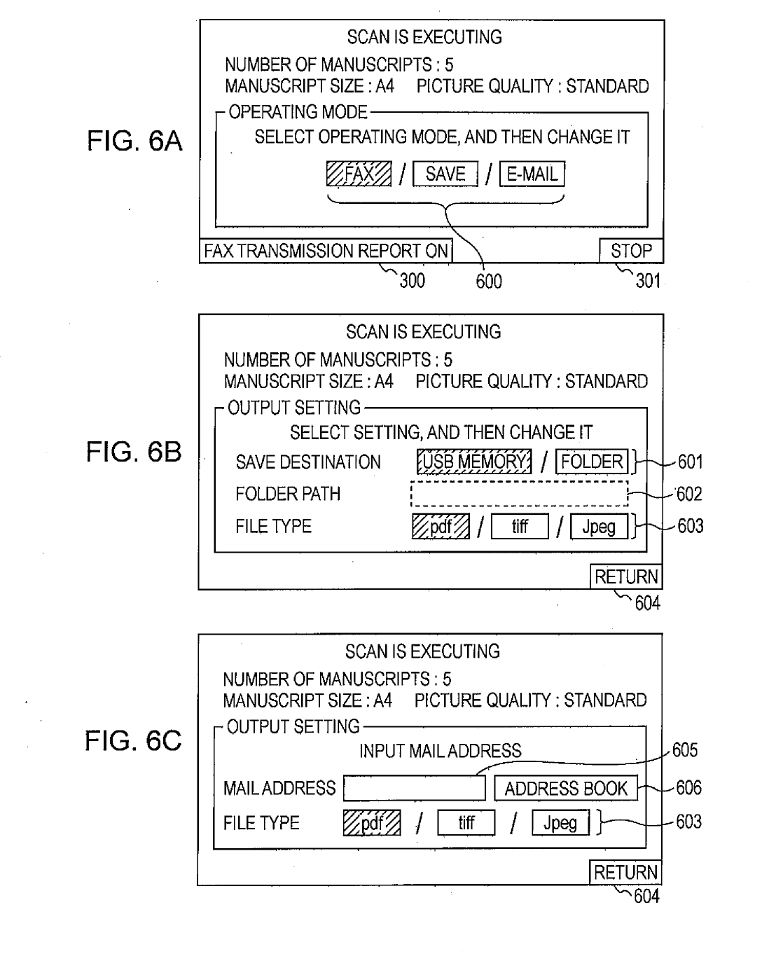

FIG. 5 shows a flow chart of an image data output process according to this embodiment, and FIG. 6A to 6C show examples of user interfaces displayed during the execution of the image data output process.

The multifunction printer 100 starts the manuscript scanning and displays a scan executing screen on a display of the control panel 111 by executing the same processes as S200 to S201 of the above described facsimile transmission mode process (S500). However, here, on the scan executing screen which is displayed, as shown in FIG. 6A, in addition to the setting change button 300 and the stop button 301 as in the above described scan executing screen, an output mode change toggle button 600 to switch an output mode from the present output mode (a facsimile transmission mode) to another output mode (a save mode or an E-mail transmission mode) are displayed.

For example, if a user does not operate the output mode setting toggle button 600 or switches again the output mode to the facsimile transmission mode by operation of the output mode change toggle button 600 (S501: Yes), the processes such as S202 to S215 in the above described facsimile transmission mode process are executed and the image data is facsimile-transmitted (S502).

On the other hand, if a user switches the output mode to the output modes other than the facsimile transmission mode by operating the output mode change toggle button 600 (S501: No), the control panel controller 112 notifies an output mode after the change to the main control board 150 and switches the contents displayed on a scan executing screen according to the instructions from the main control board 150 (S503).

For example, in a case in which a user selects the save mode, the contents displayed on a scan executing screen are switched as shown in FIG. 6B. On this scan executing screen, the output mode change toggle button 600, the setting change button 300 and the stop button 301 are not displayed whereas an output setting tool 601 to 603 to set each parameter value of the output setting information used in an output process of the save mode, a return button 604 to return the contents displayed on a scan executing screen to a state in FIG. 6A to re-change the output mode and the like are displayed. Here, the output setting tool to be displayed includes, for example, a saving destination change toggle button 601 to select which of the USB memory or the folder as a saving destination of the image data, an input field 602, to input a path of the saving destination folder of the image data, and a file type change toggle button 603 to select a type of storage file of the image data. Further, the input field 602 is displayed as active when a folder is selected as a saving destination of the image data by operation of the saving destination change toggle button 601.

In addition, in a case in which a user selected the E-mail transmission mode, the contents displayed on a scan executing screen are switched as shown in FIG. 6C. On this scan executing screen, the output mode change toggle button 600, the setting change button 300 and the stop button 301 are not displayed whereas an output setting tool 603 and 605 to set each parameter value of the output setting information used in an output process of the E-mail transmission mode, the return button 604 to return the contents displayed on a scan executing screen to a state in FIG. 6A to re-change the output mode and the like are displayed. Here, the output setting tool to be displayed includes, for example, an input field 605 to input an E-mail address of the transmission destination of the image data, a file type change toggle button 603 to select a type of storage file (attachment file) of the image data and the like. Further, in a case in which the control section 151 of the main control board 150 holds an address book data in which E-mail addresses are registered, an address book button 606 to select any E-mail address from an E-mail address list of the address book data as a transmission destination of the image data may be displayed.

It is necessary for a user to set each parameter value of the output setting information in a selected new output mode on a scan executing screen in which the displaying contents have been switched.

Next, when the completion of manuscript scanning is notified from the scanner unit 120 (S504), the control section 151 instructs the control panel controller 112 to switch the display screen to an image data output standby screen. Thereby, if the output start button on an image data output standby screen which is displayed on a display of the control panel 111 is depressed, the control panel controller 112 detects the depression of the output start button, notifies the meaning thereof to the main control board 150 and passes each parameter value of the output setting information of the output mode after the change to the main control board 150.

In the main control board 150, if the control section 151 accepts a notification from the control panel controller 112, the control section 151 reads out the image data (RAW data) accumulated in the image memory 154 during the manuscript scanning and executes an encoding process (S505) depending on the type of file indicated by the parameter of the output setting information. Then, the control section 151 creates the image data file in which the image data after encoding is stored (S506). Next, the control section 151 outputs the image data file depending on the output process according to the output mode after the change as follows.

In a case in which the output mode after the change is a save mode, the control section 151 saves the image file in a storage place indicated by the parameter of the output setting information. Specifically, if the saving destination indicated by the parameter of the output setting information is a hard disk or a designated folder on a network (S507: Yes), the control section 151 saves the image data file in that folder (S508). Whereas, if the saving destination indicated by the parameter of the output setting information is a USB memory (S507: No, S509: Yes), the control section 151 saves the image data file in a USB memory mounted to a USE port (S510).

In a case in which the output mode after the change is an E-mail transmission mode (S509: No), an E-mail destined for a mail address indicated by the parameter of the output setting information is created, and an image data file is attached to this E-mail (S511). Then, this E-mail is transmitted via a network interface (S512).

With such an image data output process, although the multifunction printer 100 starts an operation in a facsimile transmission mode, since the image data which can be obtained by scanning is accumulated in the image memory 154 of the main control board 150 until the facsimile transmission starts, it is possible to change the output mode of the multifunction printer 100 on the way without executing the manuscript scanning again until the facsimile transmission starts.

Further, although a case in which an output mode is changed on the way from the facsimile transmission mode to another output mode before starting the facsimile transmission of the image data is cited as an example in the foregoing, the change of the output mode may be accepted in the facsimile retransmission process (S215) of the above described facsimile transmission mode process. In order to do so, it is preferable that the image data (RAW data) is held in the image memory 154 of the main control board 150 until the facsimile transmission of the image data ends and, if the change of the output mode is accepted in the facsimile retransmission process (S215), the processes such as the processes following S503 are executed. With such a configuration, for example, in a case in which the facsimile transmission of the image data for a certain person is abnormally ended, a user can transmit the image data to the E-mail address destined for that person.

In addition, after start of the manuscript scanning, other output modes may be additionally set to the facsimile transmission mode. In this case, it is preferable that a scan executing screen which accepts setting of the additional output mode is displayed during the manuscript scanning. Then, if the additional output mode is not set on the scan executing screen, S202 to S215 in the above described facsimile transmission mode process are executed to facsimile transmit the image data. On the other hand, if the additional output mode is set on the scan executing screen, it is preferable that the contents displayed on the scan executing screen are switched to those for setting each parameter value of the output information in the additional output mode. Then, it is preferable that S205 to S215 in the above described facsimile transmission mode process are executed after completion of the manuscript scanning and, subsequently, S505 to S512 in the above described image data output mode process are executed.

The entire disclosure of Japanese Patent Application No. 2009-070001, filed Mar. 23, 2009 is expressly incorporated by reference herein.

What is claimed is:

1. A facsimile apparatus, comprising:
a scanner unit which acquires an image data by scanning a manuscript;
an operating section which accepts a setting information changing instruction regarding the facsimile transmission of the image data during acquisition by the scanner unit;
a main control board having a first image memory in which the image data transferred from the scanner unit during acquisition of the image data by the scanner unit is accumulated, a second setting information storage memory in which a first setting information regarding the facsimile transmission of the image data accumulated in the first image memory is stored, and a control section which, upon receiving the changing instruction after starting of the image data acquisition by the scanner unit, changes the setting information in the first setting information storage memory according to the data designated by the changing instruction;
a FAX board having a second image memory in which the image data transferred from the main control board is stored and a second setting information storage memory in which setting information in the first setting information storage memory transferred from the main control board is stored, and executing a facsimile transmission process of the image data in the second image memory according to the setting information in the second setting information storage memory; and
a plurality of buses which individually connect the main control board with each of the FAX board, the scanner unit and the operating section and transfer data between the FAX board, the scanner unit and the operating section via the main control board,
wherein the control section of the main control board transfers the image data in the first image memory to the second image memory of the FAX board upon completing the acquisition of the image data by the scanner unit.

2. The facsimile apparatus according to claim 1,
wherein the operating section includes a touch panel type display which displays a scan executing screen indicating that the scanner unit is acquiring the image data, and accepts input of the changing data by touching operation to the scan executing screen.

3. The facsimile apparatus according to claim 1,
wherein the apparatus comprises a network communication controller which is connected to a network and a removable media controller in which a removable media is mounted, and
wherein the operating section accepts a changing instruction to change an output destination of the image data being acquired by the scanner unit from the FAX board to the removable media or a folder on a network,
wherein the control section of the main control board outputs the image data in the first image memory to the output destination after the change designated by the changing operation accepted by the operating section in place of the transfer of the setting information and the image data to the FAX board.

4. A facsimile apparatus including:
a scanner unit which acquires an image data by scanning a manuscript;
a main control board having a first image memory in which the image data transferred from the scanner unit during acquisition of the image data by the scanner unit is accumulated, a network communication controller which is connected to a network, a removable media controller in which a removable media is mounted, and a control section;
a FAX board having a second image memory in which the image data transferred from the main control board is stored, and executing a facsimile transmission process of the image data in the second image memory; and
an operating section which accepts a changing instruction to change an output destination of the image data being acquired by the scanner unit from the FAX board to the removable media or a folder on network,
wherein when the operating section accepts the changing operation after starting the acquisition of the image data by the scanner unit, the control section of the main control board outputs the image data in the first image memory to the changed output destination designated by the changing operation accepted by the operating section in place of the second image memory of the FAX board.
